(19) United States
(12) Patent Application Publication
(10) Pub. No.: US 2024/0378740 A1
(43) Pub. Date: Nov. 14, 2024

(54) DISTANCE MEASURING DEVICE

(71) Applicant: Panasonic Intellectual Property Management Co., Ltd., Osaka (JP)

(72) Inventors: Mayu TABA, Osaka (JP); Masaharu FUKAKUSA, Kumamoto (JP)

(21) Appl. No.: 18/779,473

(22) Filed: Jul. 22, 2024

Related U.S. Application Data
(63) Continuation of application No. PCT/JP2023/001278, filed on Jan. 18, 2023.

(30) Foreign Application Priority Data
Jan. 25, 2022 (JP) 2022-009666

(51) Int. Cl. G06T 7/593; G06T 7/521; G06T 7/80; H04N 13/00; H04N 13/239; H04N 13/246; H04N 13/254; H04N 13/296

(52) U.S. Cl. CPC G06T 7/593; G06T 7/521; G06T 7/85; H04N 13/239; H04N 13/246; H04N 13/254; H04N 13/296; G06T 2207/10012; H04N 2013/0081

(57) ABSTRACT

A distance measuring device includes: a first imaging part and a second imaging part placed such that fields of view thereof overlap each other; a projector configured to project pattern light to a range where the fields of view overlap; a measurement part configured to measure a distance to an object surface onto which the pattern light is projected, by a stereo correspondence point search process for images from the respective imaging parts; and a controller. The projector includes an imaging adjustment part configured to change an imaging position of the pattern light in an optical axis direction of a projection lens. The controller controls the imaging adjustment part such that a density of the pattern on imaging surfaces of the respective imaging parts is included in a target range.

### CROSS REFERENCE TO RELATED APPLICATION

This application is a continuation of International Application No. PCT/JP2023/001278 filed on Jan. 18, 2023, entitled “DISTANCE MEASURING DEVICE”, which claims priority under 35 U.S.C. Section 119 of Japanese Patent Application No. 2022-009666 filed on Jan. 25, 2022, entitled “DISTANCE MEASURING DEVICE”. The disclosures of the above applications are incorporated herein by reference.

### BACKGROUND OF THE INVENTION

### Field of the Invention

The present invention relates to a distance measuring device for processing images acquired by a stereo camera and measuring the distance to an object.

### Description of Related Art

To date, a distance measuring device for processing images acquired by a stereo camera and measuring the distance to an object has been known. In this device, a parallax is detected from an image captured by each camera. A pixel block having a highest correlation with a target pixel block on one image (standard image) is searched for on another image (reference image). The search range is set in the direction of separation between the cameras with a position that is the same as that of the target pixel block, as a standard position. The pixel deviation amount of the pixel block extracted by the search, with respect to the standard position, is detected as the parallax. The distance to an object is calculated from this parallax by a triangulation method.

In such a distance measuring device, a specific pattern of light can be projected onto the object. Accordingly, even if the surface of the object is solid in color, the above search can be performed with high accuracy. However, if the distance to the object surface changes, it becomes difficult for the pattern to be properly formed on the imaging surface of each camera. In this case, the pattern projected on the imaging surface is enlarged or reduced, and the contrast of the pattern is also decreased. Therefore, it is made difficult for the above search to be performed properly.

Japanese Patent No. 6657880 describes a configuration to solve such a problem. In this configuration, a plurality of patterns respectively corresponding to a plurality of measurement distances are superimposed and projected onto an object. Accordingly, even if the distance to the object surface changes, the above-described search can be properly performed by the pattern for any of the measurement distances.

However, the above configuration requires complicated work such as creating a plurality of patterns respectively corresponding to a plurality of measurement distances in advance. In addition, depending on the pattern, other patterns may become noise, and it may happen that the above-described search cannot be performed properly.

### SUMMARY OF THE INVENTION

A distance measuring device according to a main aspect of the present invention includes: a first imaging part and a second imaging part placed so as to be aligned such that fields of view thereof overlap each other; a projector configured to project pattern light distributed in a predetermined pattern, to a range where the fields of view overlap; a measurement part configured to perform a stereo correspondence point search process for images acquired by the first imaging part and the second imaging part, respectively, to measure a distance to an object surface onto which the pattern light is projected; and a controller configured to control the projector. The projector includes a light source, a pattern generator configured to generate the pattern light from light emitted from the light source, at least one projection lens configured to project the pattern light, and an imaging adjustment part configured to change an imaging position of the pattern light by the projection lens in an optical axis direction of the projection lens. The controller controls the imaging adjustment part such that the imaging position of the pattern light is an imaging position corresponding to the distance to the object surface. Here, the controller controls the imaging adjustment part such that a density of the pattern projected on imaging surfaces of the first imaging part and the second imaging part is included in a target range.

In the distance measuring device according to this aspect, the imaging adjustment part is controlled such that the imaging position of the pattern light is the imaging position corresponding to the distance to the object surface. Therefore, even if the distance to the object surface changes, the pattern can be properly distributed on the imaging surfaces of the first imaging part and the second imaging part. In addition, since the imaging position of the pattern light is adjusted by the imaging adjustment part, there is no need to create a plurality of patterns respectively corresponding to a plurality of measurement distances in advance. Therefore, a stereo correspondence point search using the pattern light can be performed properly with a simple configuration.

The effects and the significance of the present invention will be further clarified by the description of the embodiment below. However, the embodiment below is merely an example for implementing the present invention. The present invention is not limited to the description of the embodiment below in any way.

### BRIEF DESCRIPTION OF THE DRAWINGS

FIG. 1 is a diagram showing a configuration of a distance measuring device according to an embodiment;

FIG. 2A and FIG. 2B are each a diagram schematically showing a method for setting a pixel block for a first image according to the embodiment;

FIG. 3A is a diagram schematically showing a state where a target pixel block is set on the first image according to the embodiment;

FIG. 3B is a diagram schematically showing a search range set on a second image for searching for the target pixel block in FIG. 3A according to the embodiment;

FIG. 4A to FIG. 4D are each a diagram schematically showing a search process according to the embodiment;

FIG. 5A is a graph showing the relationship between a search position and a correlation value according to the embodiment;

FIG. 5B is a graph showing the relationship between the density of a pattern and the search accuracy of a matching pixel block according to the embodiment;

FIG. 6A and FIG. 6E are each a diagram schematically showing a state where a pattern of pattern light is formed on an imaging surface of a first imaging part according to the embodiment;

FIG. 6C is a diagram schematically showing a state where the pattern of the pattern light is not formed on the imaging surface of the first imaging part according to the embodiment;

FIG. 6B, FIG. 6D, and FIG. 6F are each a diagram schematically showing a part of a first image acquired by the first imaging part in a state of FIG. 6A, FIG. 6C, or FIG. 6E;

FIG. 7 is a flowchart showing a process for measuring the distance to an object surface according to the embodiment;

FIG. 8A is a diagram schematically showing a process for adjusting a focal distance using an evaluation value according to the embodiment;

FIG. 8B shows a table in which an evaluation value and a correction amount for the focal distance are associated with each other in advance, according to the embodiment;

FIG. 9A and FIG. 9B each illustrate a method for acquiring an evaluation value according to the embodiment;

FIG. 10A and FIG. 10B each illustrate another method for acquiring an evaluation value according to the embodiment;

FIG. 11A and FIG. 11B are each a diagram schematically showing an example of the use form of the distance measuring device according to the embodiment;

FIG. 12 is a flowchart showing a process executed by a controller during operation of a robot arm according to the embodiment;

FIG. 13 is a flowchart showing a process for measuring the distance to an object surface according to Modification 1;

FIG. 14 is a flowchart showing a process for measuring the distance to an object surface according to Modification 2; and

FIG. 15A to FIG. 15C are each a diagram schematically showing a configuration of a projection lens according to another modification.

It is noted that the drawings are solely for description and do not limit the scope of the present invention in any way.

### DETAILED DESCRIPTION

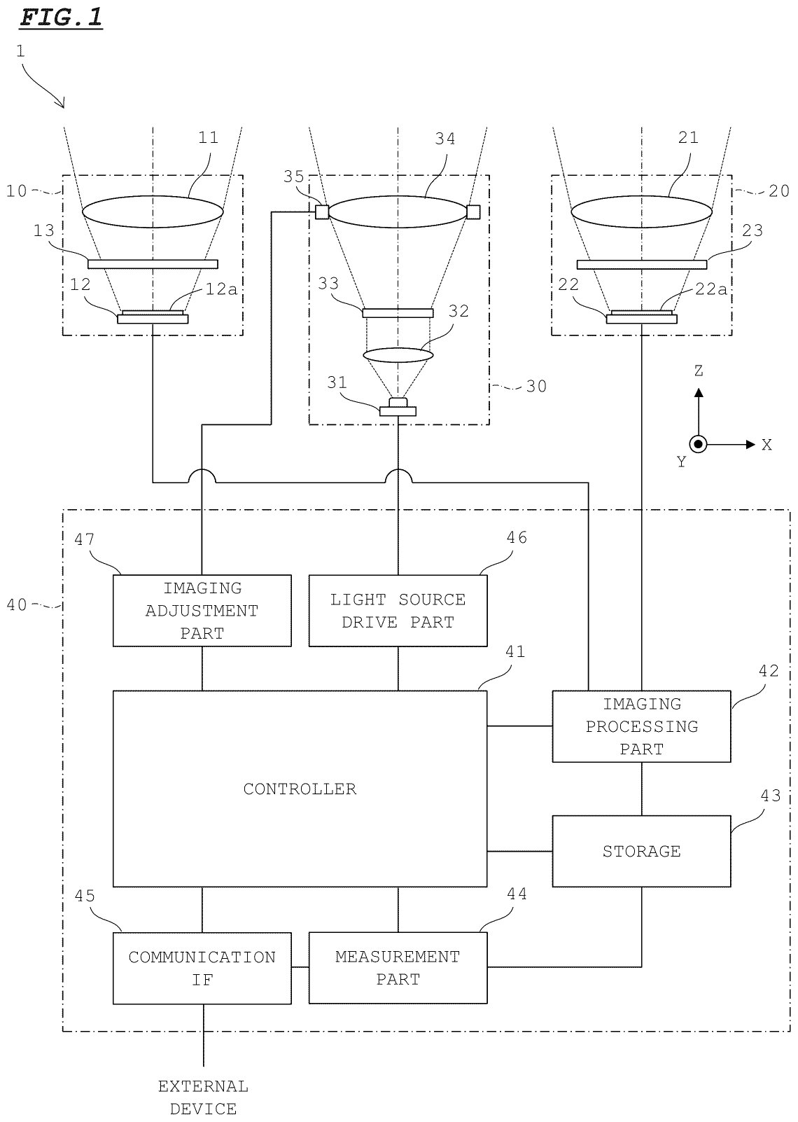

Hereinafter, an embodiment of the present invention will be described with reference to the drawings. For convenience, in FIG. 1, X, Y, and Z axes that are orthogonal to each other are additionally shown. The X-axis direction is an alignment direction of a first imaging part and a second imaging part, and the Z-axis positive direction is the imaging direction of each imaging part.

FIG. 1 is a diagram showing a configuration of a distance measuring device 1.

The distance measuring device 1 includes a first imaging part 10, a second imaging part 20, a projector 30, and an image processor 40.

The first imaging part 10 includes an imaging lens 11, an imaging element 12, and a filter 13. The imaging lens 11 condenses light from a viewing area, onto an imaging surface 12a of the imaging element 12. The imaging element 12 is a CMOS image sensor. The imaging element 12 may be a CCD. The filter 13 transmits light in the same wavelength band as light projected from the projector 30 and blocks light in the other wavelength bands.

The second imaging part 20 has the same configuration as the first imaging part 10. The second imaging part 20 includes an imaging lens 21, an imaging element 22, and a filter 23. The imaging lens 21 condenses light from a viewing area, onto an imaging surface 22a of the imaging element 22. The imaging element 22 is a CMOS image sensor. The imaging element 22 may be a CCD. The filter 23 transmits light in the same wavelength band as the light projected from the projector 30 and blocks light in the other wavelength bands.

The first imaging part 10 and the second imaging part 20 are placed so as to be aligned in the X-axis direction such that fields of view thereof overlap each other. The imaging directions of the first imaging part 10 and the second imaging part 20 are the Z-axis positive direction. The imaging direction of the first imaging part 10 may be slightly inclined in the direction to the second imaging part 20 from the Z-axis positive direction, and the imaging direction of the second imaging part 20 may be slightly inclined in the direction to the first imaging part 10 from the Z-axis positive direction. The positions in the Z-axis direction and the positions in the Y-axis direction of the first imaging part 10 and the second imaging part 20 are the same as each other.

The projector 30 projects pattern light that is distributed in a predetermined pattern, to a range where the field of view of the first imaging part 10 and the field of view of the second imaging part 20 overlap. The direction in which the pattern light is projected by the projector 30 is the Z-axis positive direction. The projector 30 includes a light source 31, a collimator lens 32, a pattern generator 33, a projection lens 34, and a lens drive part 35.

The light source 31 emits laser light having a predetermined wavelength. The light source 31 is, for example, a semiconductor laser. The emission wavelength of the light source 31 is, for example, included in the infrared wavelength band. The light source 31 may be another type of light source, such as an LED (Light Emitting Diode). The collimator lens 32 converts the light emitted from the light source 31, into substantially collimated light.

The pattern generator 33 generates pattern light from the light emitted from the light source 31. In the present embodiment, the pattern generator 33 is a transmission-type diffractive optical element (DOE). The diffractive optical element (DOE), for example, has a diffraction pattern with a predetermined number of steps on an incident surface thereof. Due to the diffraction action by the diffraction pattern, the laser light incident on the diffractive optical element (pattern generator 33) is divided into a plurality of lights to be converted into a predetermined pattern of light. The generated pattern is a pattern that can maintain uniqueness for each pixel block 102 described later.

In the present embodiment, the pattern generated by the diffractive optical element (DOE) is a pattern in which a plurality of dot regions (hereinafter referred to as “dots”), which are regions through which light passes, are randomly distributed. However, the pattern generated by the diffractive optical element (DOE) is not limited to the pattern with dots, and may be another pattern. The pattern generator 33 may be a reflection-type diffractive optical element, or may be a photomask. Alternatively, the pattern generator 33 may be a device that generates a fixed pattern of pattern light by a control signal, such as a DMD (Digital Mirror Device) and a liquid crystal display.

The projection lens 34 projects the pattern light generated by the pattern generator 33. The projection lens 34 is composed of at least one lens. In the present embodiment, the projection lens 34 includes a liquid lens whose focal distance can be changed. A voltage is applied to the liquid lens via the lens drive part 35. When the voltage applied to the liquid lens is changed, the focal distance of the liquid lens changes. Accordingly, the focal distance of the projection lens 34 is changed, so that the imaging position of the pattern light is changed in the optical axis direction of the projection lens 34.

The image processor 40 includes a controller 41, an imaging processing part 42, a storage 43, a measurement part 44, a communication interface 45, a light source drive part 46, and an imaging adjustment part 47.

The controller 41 is composed of a microcomputer or the like, and controls each part according to a predetermined program stored in an internal memory thereof. The imaging processing part 42 controls the imaging elements 12 and 22, and performs processing such as luminance correction and camera calibration on pixel signals of a first image and a second image outputted from the imaging elements 12 and 22, respectively. The storage 43 stores therein the first image outputted from the first imaging part 10 and processed by the imaging processing part 42 and the second image outputted from the second imaging part 20 and processed by the imaging processing part 42.

The measurement part 44 compares and processes the first image and the second image stored in the storage 43, and performs a stereo correspondence point search to acquire the distance to an object projected on each pixel block on the first image. The measurement part 44 temporarily stores the acquired distance information in association with each pixel block, and transmits the stored distance information for all the pixel blocks to an external device via the communication interface 45.

That is, the measurement part 44 sets a pixel block to be the target for distance acquisition (hereinafter referred to as “target pixel block”) on the first image, and searches for a pixel block corresponding to the target pixel block, that is, a pixel block that best matches the target pixel block (hereinafter referred to as “matching pixel block”), in a search range defined on the second image. Then, the measurement part 44 performs a process of acquiring a pixel deviation amount between a pixel block at the same position as the target pixel block on the second image (hereinafter referred to as “standard pixel block”) and the matching pixel block extracted from the second image by the above search, and calculating the distance to the object at the position of the target pixel block from the acquired pixel deviation amount.

The imaging processing part 42, the storage 43, the measurement part 44, and the communication interface 45 may be configured by a semiconductor integrated circuit composed of an FPGA (Field Programmable Gate Array). Alternatively, these parts may be configured by another semiconductor integrated circuit such as a DSP (Digital Signal Processor), a GPU (Graphics Processing Unit), and an ASIC (Application Specific Integrated Circuit).

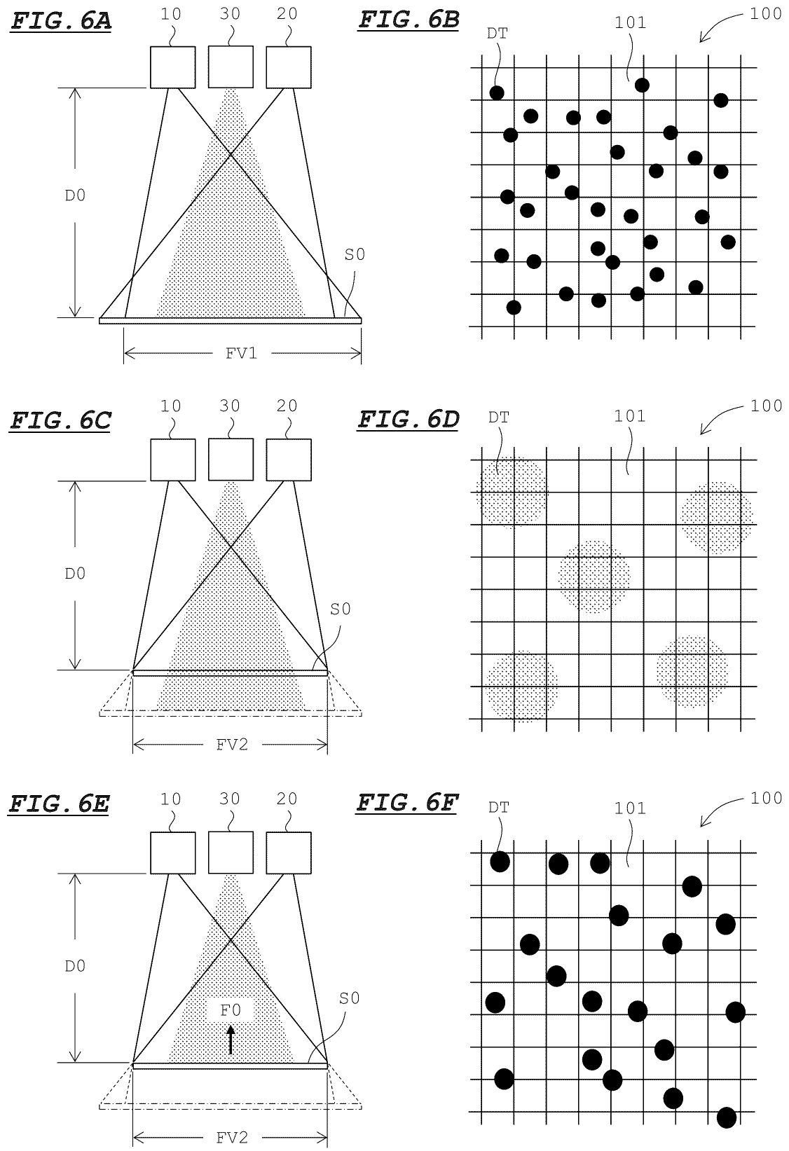

The light source drive part 46 drives the light source 31 under control from the controller 41. The imaging adjustment part 47 drives the lens drive part 35 and adjusts the focal distance of the projection lens 34 under control from the controller 41. A process for adjusting the focal distance for the projection lens 34 will be described later with reference to FIG. 6 to FIG. 10B.

Next, the process in the measurement part 44 will be described.

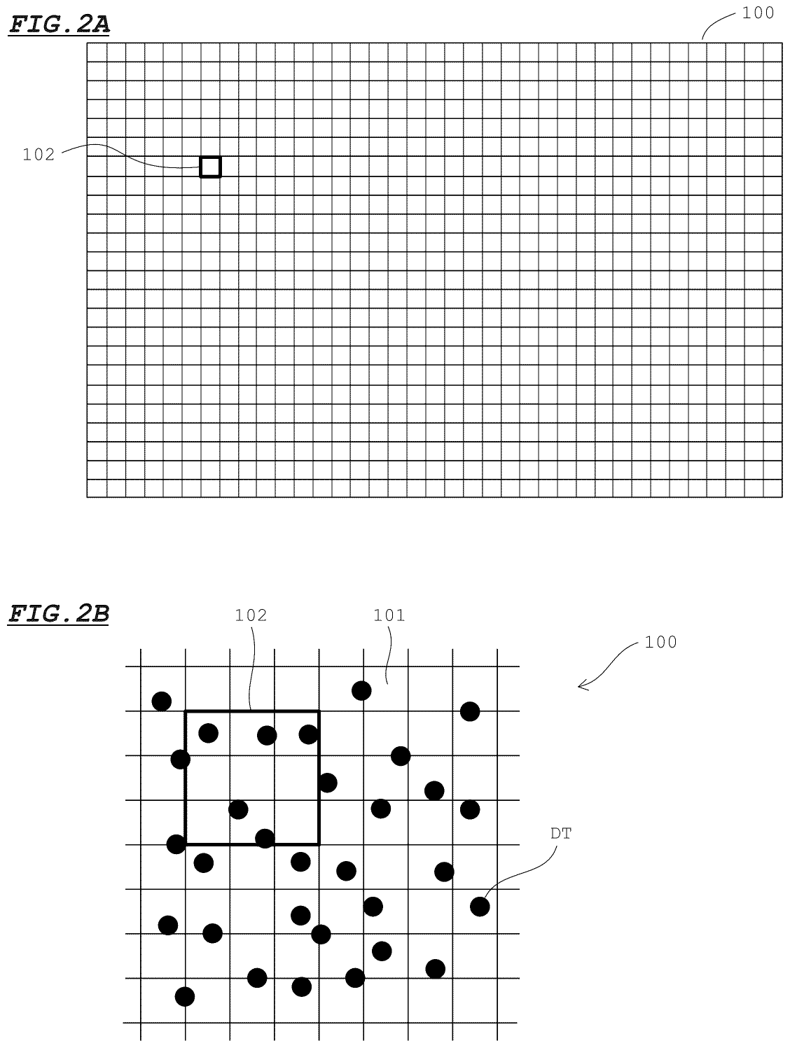

FIG. 2A and FIG. 2B are each a diagram schematically showing a method for setting a pixel block 102 for a first image 100. FIG. 2A shows a method for setting the pixel block 102 for the entire first image 100, and FIG. 2B shows a partial region of the first image 100 in an enlarged manner.

As shown in FIG. 2A and FIG. 2B, the first image 100 is divided into a plurality of pixel blocks 102 each including a predetermined number of pixel regions 101. Each pixel region 101 is a region corresponding to one pixel on the imaging element 12. That is, each pixel region 101 is a smallest unit of the first image 100. In the example in FIG. 2A and FIG. 2B, one pixel block 102 is composed of nine pixel regions 101 arranged in three rows and three columns. However, the number of pixel regions 101 included in one pixel block 102 is not limited thereto.

If the imaging position of the pattern light by the projection lens 34 matches the distance to the object surface, the pattern (dots DT) of the pattern light is distributed on the first image 100 in a predetermined distribution state (size, density, interval) as shown in FIG. 2B. In this case, the pattern (dots) of the pattern light is also distributed on the second image acquired from the second imaging part 20, in the same distribution state as on the first image 100.

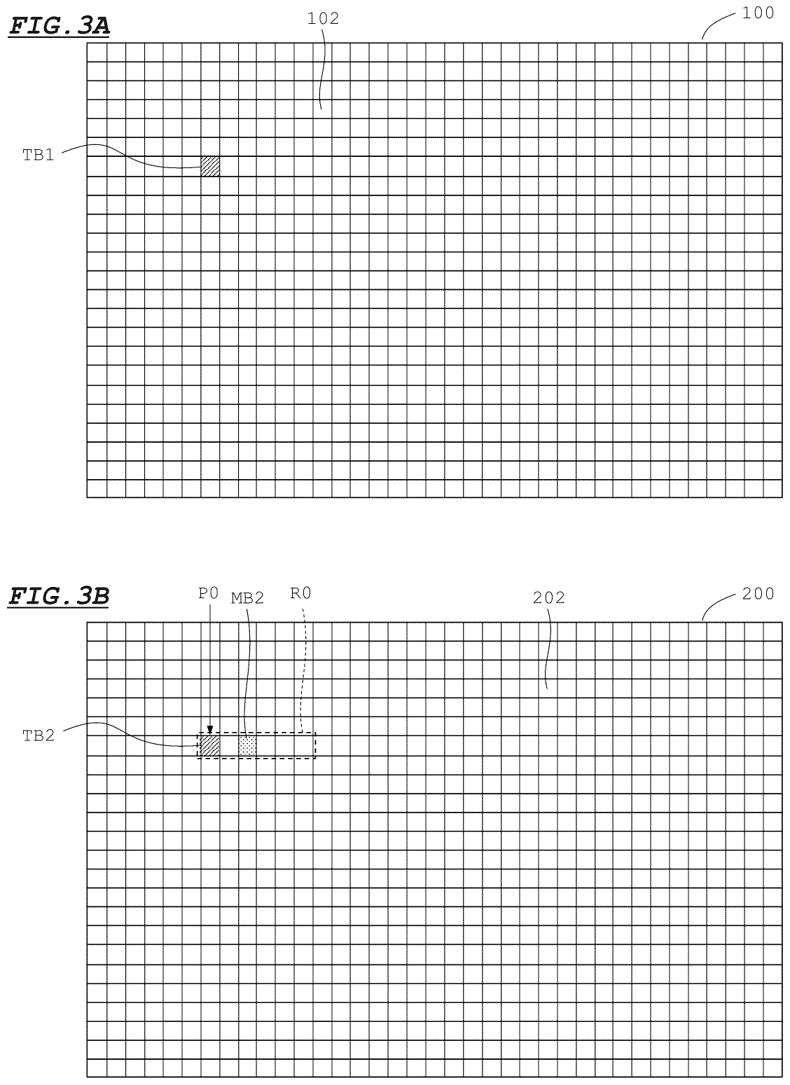

FIG. 3A is a diagram schematically showing a state where a target pixel block TB1 is set on the first image 100, and FIG. 3B is a diagram schematically showing a search range R0 set on a second image 200 in order to search for the target pixel block in FIG. 3A.

In FIG. 3B, for convenience, similar to the first image 100, the second image 200 acquired from the second imaging part 20 is divided into a plurality of pixel blocks 202. Each pixel block 202 includes pixel regions whose number is the same as in the pixel blocks 102 described above.

In FIG. 3A, the target pixel block TB1 is a pixel block 102 to be processed among the pixel blocks 102 on the first image 100. In addition, in FIG. 3B, a standard pixel block TB2 is the pixel block 202, on the second image 200, at the same position as the target pixel block TB1.

The measurement part 44 reads the first image 100 and the second image 200 captured at the same timing, from the storage 43, and processes these images. The measurement part 44 identifies the standard pixel block TB2 at the same position as the target pixel block TB1, on the second image 200. Then, the measurement part 44 sets the position of the identified standard pixel block TB2 as a standard position P0 of the search range R0, and sets a range extending from the standard position P0 in the direction of separation between the first imaging part 10 and the second imaging part 20, as the search range R0.

The direction in which the search range R0 extends is set to a direction in which a pixel block (matching pixel block MB2) corresponding to the target pixel block TB1 deviates from the standard position P0 on the second image 200 due to a parallax. Here, the search range R0 is set as a range of six pixel blocks 202 aligned in the right direction (direction corresponding to the X-axis direction in FIG. 1) from the standard position P0. However, the number of pixel blocks 202 included in the search range R0 is not limited to this number. In addition, the starting point of the search range R0 is not limited to the standard pixel block TB2, and, for example, a position shifted from the standard pixel block TB2 in the right direction by several blocks may be set as the starting point of the search range R0.

The measurement part 44 searches for the pixel block (matching pixel block MB2) corresponding to the target pixel block TB1, in the search range R0 set as described above.

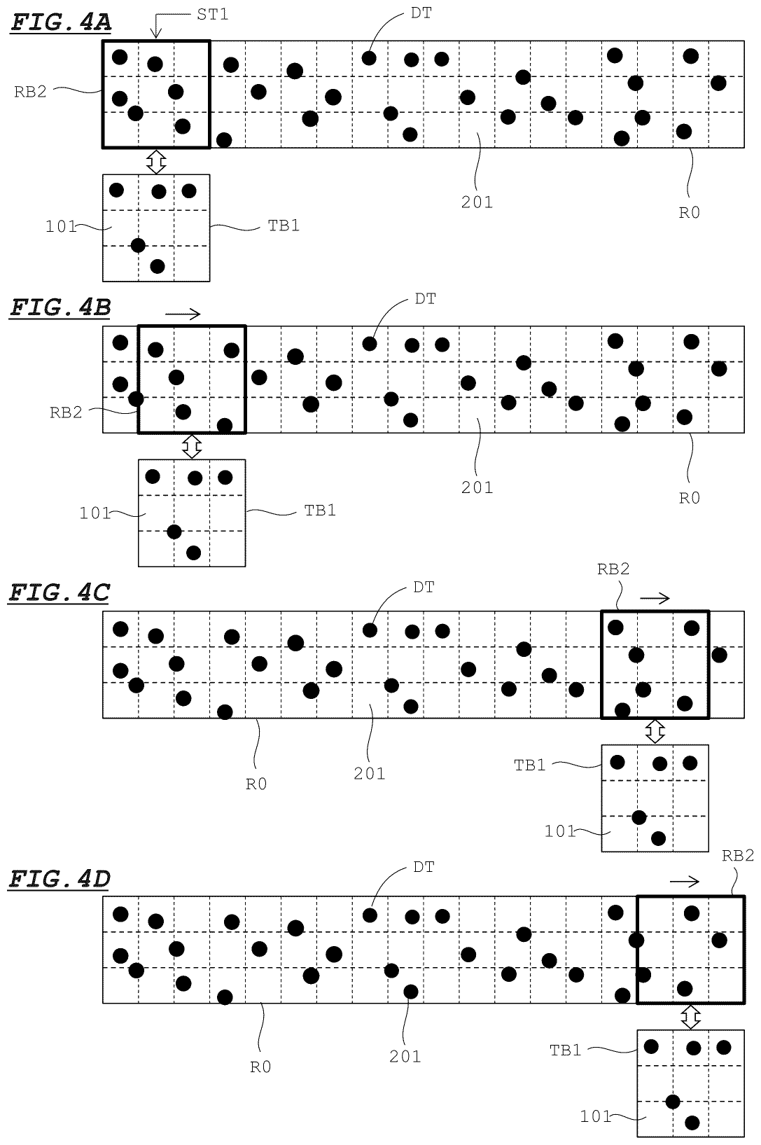

FIG. 4A to FIG. 4D are each a diagram schematically showing a process for searching the matching pixel block MB2 in the search range R0.

First, as shown in FIG. 4A, the measurement part 44 sets a search start position ST1 of the search range R0 as a search position. Next, the measurement part 44 sets a reference pixel block RB2 having the same size as the target pixel block TB1, at this search position, and calculates a correlation value between the target pixel block TB1 and the reference pixel block RB2.

Here, the correlation value is acquired, for example, as a value (SAD) obtained by calculating the differences between the pixel values (luminance) for the mutually corresponding pixel regions 101 and 201 in the target pixel block TB1 and the reference pixel block RB2 and adding up all the absolute values of the respective calculated differences. Alternatively, the correlation value may be acquired as a value (SSD) obtained by adding up all the squared values of the above differences. However, the calculation method for the correlation value is not limited to these methods, and other calculation methods may be used as long as a correlation value that serves as an index of the correlation between the target pixel block TB1 and the reference pixel block RB2 is acquired.

Then, when the process for one reference pixel block RB2 is completed, the measurement part 44 sets the next search position as shown in FIG. 4B. Specifically, the measurement part 44 sets a position shifted from the last search position in the direction to the end of the search range R0 by one pixel, as a search position this time. Then, the measurement part 44 calculates a correlation value between the reference pixel block RB2 at the search position this time and the target pixel block TB1 by the same process as above.

The measurement part 44 repeats the same process while shifting the search position in the direction to the end by one pixel. FIG. 4C shows a state where the reference pixel block RB2 is set at the search position immediately before the final search position in the search range R0, and FIG. 4D shows a state where the reference pixel block RB2 is set at the final search position in the search range R0.

Then, when the process for the final search position is completed, the measurement part 44 acquires the search position at which the correlation value is minimum, among the sequentially set search positions. Then, the measurement part 44 extracts the reference pixel block RB2 at the search position at which the minimum correlation value has been acquired, as the pixel block (matching pixel block MB2) corresponding to the target pixel block TB1. Furthermore, the measurement part 44 acquires a pixel deviation amount of the matching pixel block MB2 with respect to the target pixel block TB1. Then, the measurement part 44 calculates the distance to the object surface by a triangulation method from the acquired pixel deviation amount and the separation distance between the first imaging part 10 and the second imaging part 20. The measurement part 44 temporarily stores the calculated distance as the distance to the object surface in a direction corresponding to the target pixel block TB1.

The measurement part 44 repeats the same process for all target pixel blocks TB1 on the first image 100. Then, when the distances are acquired for all the target pixel blocks TB1, the measurement part 44 transmits the temporarily stored distances for all the target pixel blocks TB1 to the external device via the communication interface 45.

Accordingly, the measurement part 44 ends the process for the first image 100 and the second image 200 acquired at the same timing. The measurement part 44 sequentially performs the same process for the first images 100 and the second images 200 acquired at subsequent timings, and sequentially transmits the distances acquired for all target pixel blocks TB1 on the first images 100, to the external device via the communication interface 45.

In the above search process, since the pattern light is projected to the object surface, even if the object surface has substantially uniform reflection intensity such as being solid in color, a smooth and proper search can be performed for the matching pixel block MB2 which matches the target pixel block TB1. That is, a pattern (dots) included in each target pixel block TB1 is specific, and a pattern (dots) included in each reference pixel block RB2 is specific. Therefore, the correlation value calculated during the search process tends to differ for each reference pixel block RB2 to be compared. Thus, even if the object surface is solid in color or the like, the correlation value is likely to become minimum like a peak at the search position of the matching pixel block MB2, so that a proper search can be performed for the matching pixel block MB2.

The density of the pattern (dots) of the pattern light projected onto the imaging surfaces 12a and 22a can be adjusted such that a combination of pixel values of the plurality of pixels included in the target pixel block TB1 differs among the target pixel blocks TB1 and a combination of pixel values of the plurality of pixels included in the reference pixel block RB2 differs among the reference pixel blocks RB2.

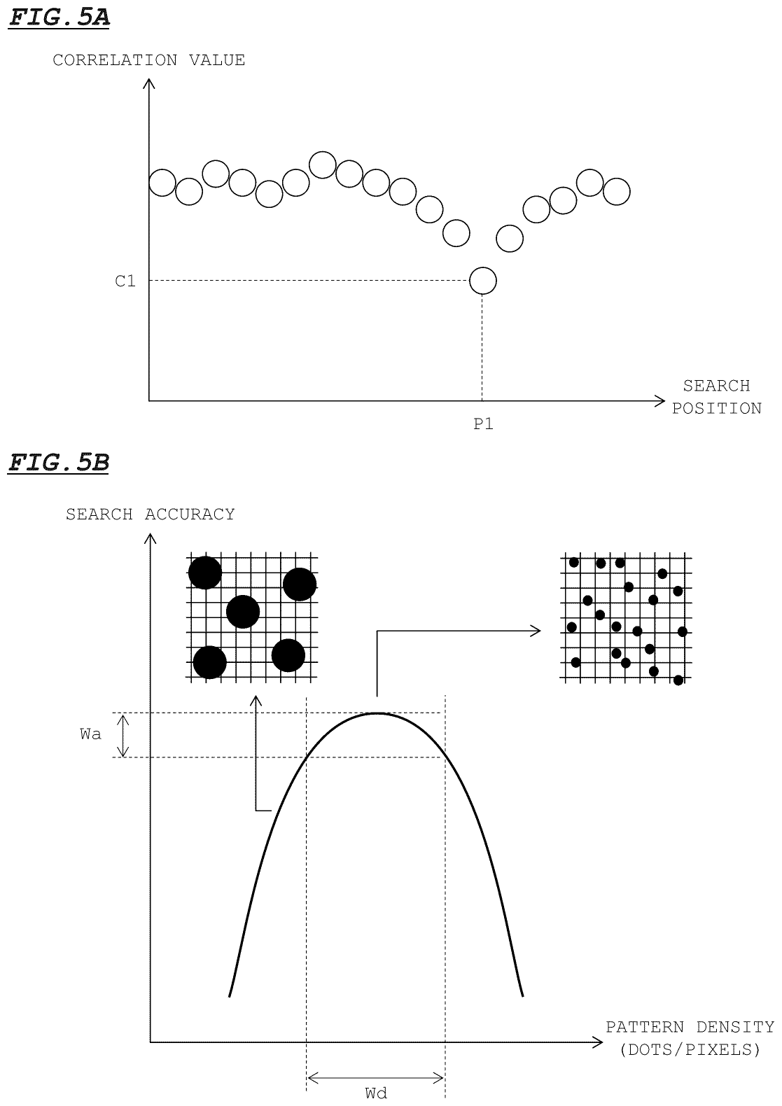

FIG. 5A is a graph illustrating the relationship between the search position and the correlation value.

In this example, the pattern (dots) of the pattern light projected onto the imaging surfaces 12a and 22a is sufficiently specific for each pixel block. Therefore, a correlation value C1 acquired at a search position P1 which is the position of the matching pixel block MB2 is significantly small to the extent that the correlation value C1 is clearly distinguishable from correlation values at other positions. Accordingly, the minimum correlation value C1 is acquired at the search position P1. Thus, the search position P1 is appropriately identified as the position of the matching pixel block MB2.

On the other hand, if the specificity of the pattern (dots) for each pixel block decreases, the differences between the correlation value C1 acquired at the position of the matching pixel block MB2 and the correlation values at the other positions become smaller. Therefore, due to the influence of noise, etc., the correlation value at another position different from the position of the matching pixel block MB2 may become a minimum value, and this position may be erroneously detected as the position of the matching pixel block MB2.

The factors that influence the specificity of the pattern (dots) for each pixel block may include the density, the interval, and the contrast of the pattern (dots), etc.

FIG. 5B is a graph showing the relationship between the density of the pattern and the search accuracy of the matching pixel block MB2.

FIG. 5B conceptually shows the relationship with the search accuracy of the matching pixel block MB2 in the graph and the distribution state of dots at locations on the graph. For example, when a range including all dots is set, the density of the dots is acquired as a number obtained by dividing the number of dots included inside this range by the number of pixels included inside this range. Alternatively, when a region having a sufficient size is set in the dot distribution range, the density of the dots is acquired as a value obtained by dividing the number of dots included in this region by the number of pixels included in this region. In this calculation, the number of dots may be the total area of the dots, and the number of pixels may be the total area of the pixels. If the pattern is composed of elements other than dots, a density calculation method using the areas of the elements can be applied.

The distribution state on the right side of FIG. 5B has a higher density than the distribution state on the left side of FIG. 5B. In the distribution state on the right side, 19 dots are distributed for 8×8 pixels, that is, 64 pixels, and thus the density is 19/64. In the distribution state on the left side, 5 dots are distributed for 8×8 pixels, that is, 64 pixels, and thus the density is 5/64. Therefore, the density in the distribution state on the right side is about 4 times the density in the distribution state on the left side.

As shown in FIG. 5B, if the density of the pattern (dots) is within a range Wd, a high search accuracy Wa can be maintained. Therefore, the density of the pattern (dots) may be set within the range Wd. The density of the pattern (dots) of the pattern light projected onto the imaging surfaces 12a and 22a is set to a value at which the search accuracy can be maintained high.

Meanwhile, as described above, when the pattern light is projected by the projector 30, if the distance to the object surface to be measured changes, it becomes difficult for the pattern of the pattern light to be properly formed on the imaging surfaces 12a and 22a. In this case, the pattern projected on the imaging surfaces 12a and 22a is enlarged or reduced, and the contrast of the pattern is also decreased. Therefore, it is made difficult for the above-described search process to be performed properly.

Therefore, in the present embodiment, the imaging adjustment part 47 is controlled such that the imaging position of the pattern light is an imaging position corresponding to the distance to the object surface. This control will be described below.

FIG. 6A is a diagram schematically showing a state where the pattern of the pattern light is formed on the imaging surface 12a of the first imaging part 10. FIG. 6B is a diagram schematically showing a part of the first image 100 acquired by the first imaging part 10 in the state of FIG. 6A.

In FIG. 6A, the focal distance of the projection lens 34 is in a state of allowing the pattern of the pattern light to be formed on the imaging surface 12a of the first imaging part 10. Therefore, as shown in FIG. 6B, the pattern (dots DT) of the pattern light is distributed on the first image 100 at a proper density and interval. In addition, the luminance and the contrast of the pattern (dots DT) are maintained high.

FIG. 6C is a diagram schematically showing a state where the pattern of the pattern light is not formed on the imaging surface 12a of the first imaging part 10. FIG. 6D is a diagram schematically showing a part of the first image 100 acquired by the first imaging part 10 in the state of FIG. 6C.

In FIG. 6C, the focal distance of the projection lens 34 is the same as in FIG. 6A. On the other hand, an object surface S0 is closer to the first imaging part 10 and the second imaging part 20 than in FIG. 6A, and a distance DO between the projector 30 and the object surface S0 is smaller. In addition, with the approach of the object surface S0, a field of view FV2 of the first imaging part 10 is smaller than a field of view FV1 in the case of FIG. 6A. Therefore, as shown in FIG. 6D, as compared to FIG. 6B, the pattern (dots DT) of the pattern light distributed on the first image 100 is enlarged, and the luminance and the contrast of the pattern (dots DT) are decreased.

In this case, the controller 41 controls the imaging adjustment part 47 to change a focal distance FO of the projection lens 34 such that the imaging position of the pattern (dots DT) of the pattern light is the position of the imaging surfaces 12a and 22a of the first imaging part 10 and the second imaging part 20 as shown in FIG. 6E. Accordingly, as shown in FIG. 6F, the pattern (dots DT) of the pattern light is properly projected on the first image 100 with high luminance and high contrast.

That is, in the configuration in FIG. 1, when the emission surface of the pattern generator 33 (DOE) is defined as an object surface and the imaging surface of the pattern light by the projection lens 34 is defined as an image surface, the focal distance of the projection lens 34 is adjusted such that the image surface approaches the imaging surfaces 12a and 22a of the first imaging part 10 and the second imaging part 20. Accordingly, the pattern (dots DT) of the pattern light on the first image 100 is maintained in substantially the same luminance and contrast state as in the case of FIG. 6A.

As shown in FIG. 6E, when the object surface S0 approaches the first imaging part 10, the second imaging part 20, and the projector 30, the size of the dots DT on the first image 100 becomes larger and the density of the dots DT becomes lower than in the case of FIG. 6A. Therefore, the pattern of the pattern light generated by the pattern generator 33 may be set such that the density of the pattern is included in the range Wd in FIG. 5B at any focal distance when the focal distance of the projection lens 34 is adjusted within the distance range to be measured. Accordingly, the controller 41 can control the imaging adjustment part 47 such that the density of the pattern projected on the imaging surfaces 12a and 22a of the first imaging part 10 and the second imaging part 20 is included in the target range Wd.

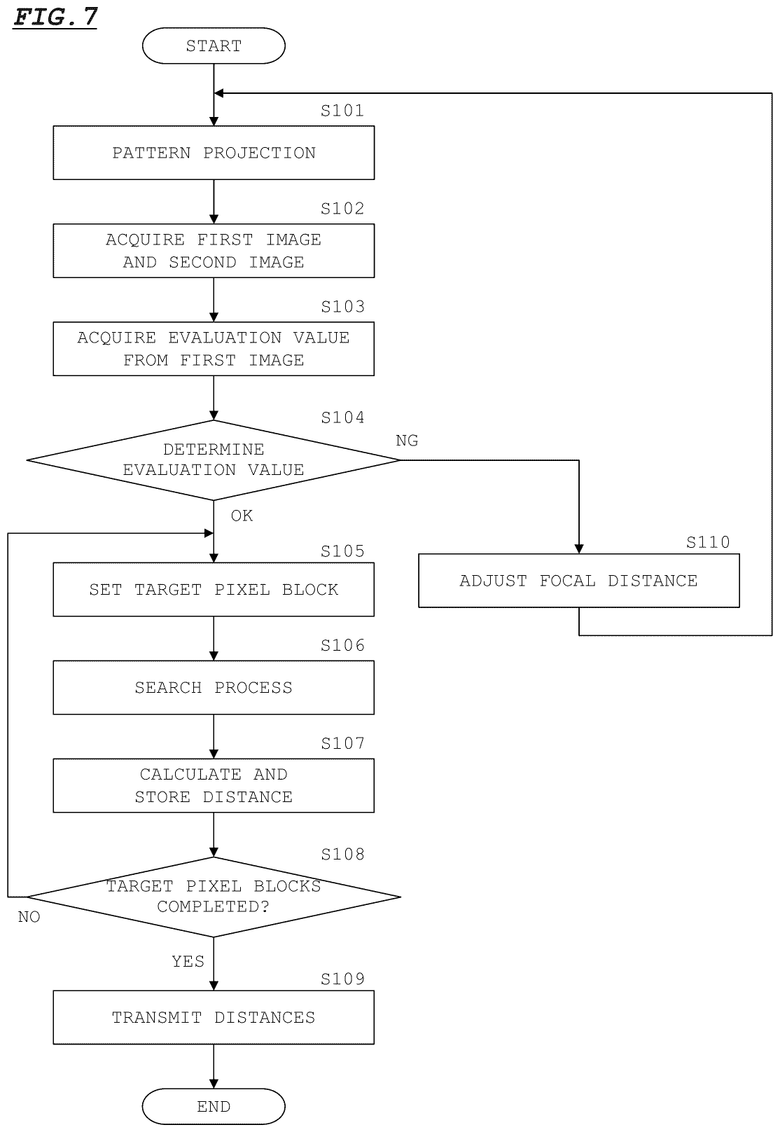

FIG. 7 is a flowchart showing a process for measuring the distance to the object surface S0.

First, the controller 41 drives the light source 31 via the light source drive part 46 in a state where the focal distance of the projection lens 34 is set to an initial value. Accordingly, the pattern light is projected from the projector 30 (S101). Next, the controller 41 causes the imaging processing part 42 to acquire the first image 100 and the second image 200 during a pattern light projection period (S102). The acquired first image 100 and second image 200 are stored in the storage 43.

The controller 41 acquires an evaluation value allowing evaluation of the state of the pattern of the pattern light projected on the imaging surface 12a of the first imaging part 10, from the first image 100 stored in the storage 43 (S103). Then, the controller 41 determines whether or not the acquired evaluation value is within a proper range (S104).

The proper range to which the evaluation value is compared in step S104 is a range obtained by adding and subtracting a permissible variation value to and from an optimum value for an evaluation value acquired when the pattern of the pattern light is formed on the imaging surface 12a (optimum evaluation value). Therefore, if the evaluation value is within the proper range, it can be inferred that the pattern of the pattern light is in a state of being formed substantially on the imaging surface 12a.

If the evaluation value is within the proper range (S104: OK), the controller 41 causes the measurement part 44 to execute a distance calculation process based on a stereo correspondence point search (S105 to S108) as described with reference to FIG. 3A to FIG. 4D. That is, the measurement part 44 sets the target pixel block TB1 on the first image 100 (S105), and searches for the matching pixel block MB2 which matches the target pixel block TB1, on the second image 200 (S106). Next, the measurement part 44 calculates the distance to the object surface in the direction corresponding to the target pixel block TB1 as described above, based on the searched matching pixel block MB2, and temporarily stores the calculated distance (S107).

The measurement part 44 performs the same process until the calculation and storage of distances for all target pixel blocks TB1 are completed (S108: NO). Then, when the calculation and storage of distances for all the target pixel blocks TB1 are completed (S108: YES), the measurement part 44 transmits the temporarily stored distances for all the target pixel blocks TB1 to the external device via the communication interface 45 (S109). Then, the controller 41 ends the process.

On the other hand, if the evaluation value is not within the proper range (S104: NG), the controller 41 adjusts the focal distance of the projection lens 34 such that an evaluation value within the proper range is acquired (S110). Then, the controller 41 returns the process to step S101, and performs the same process again with the pattern light projected at the adjusted focal distance (S101 to S103). Through this process, the controller 41 acquires an evaluation value again, and determines whether or not the acquired evaluation value is within the proper range (S104). If the evaluation value is within the proper range, the controller 41 advances the process to step S105 and executes the process described above.

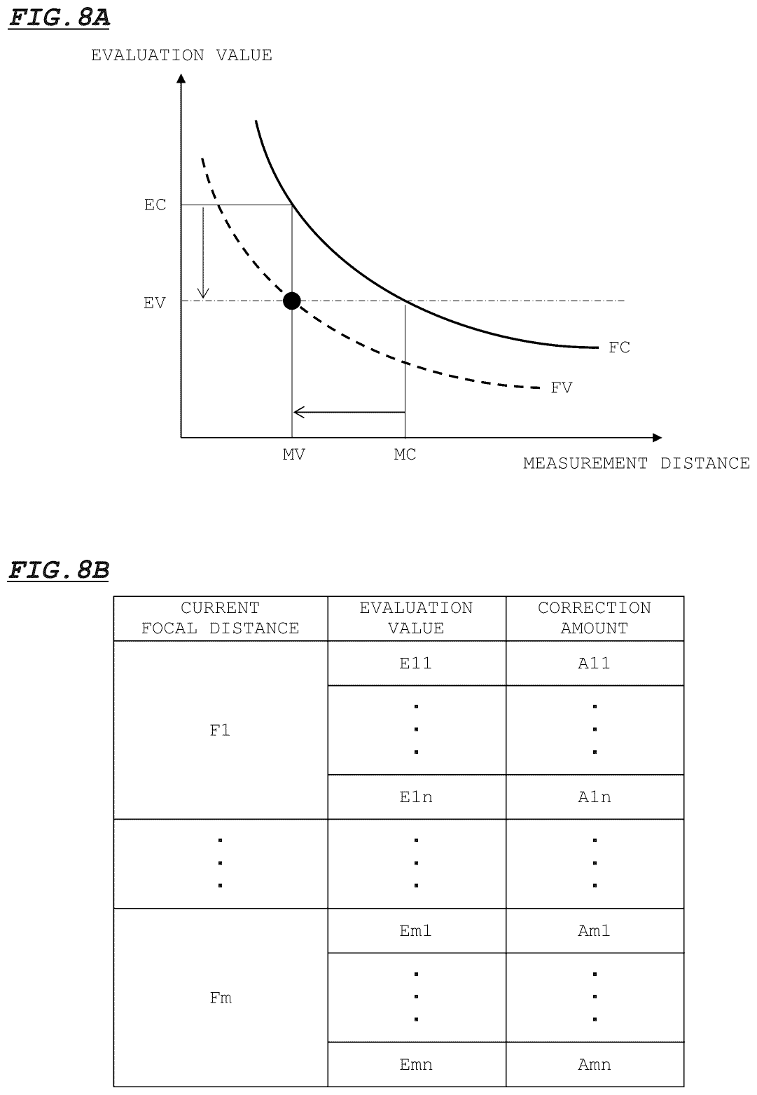

FIG. 8A is a diagram schematically showing a process for adjusting the focal distance using the evaluation value in step S110 in FIG. 7.

As shown in FIG. 8A, the evaluation value changes as the distance to the object surface (measurement distance) changes. That is, when the current focal distance of the projection lens 34 is a focal distance FC, the state of the pattern projected on the imaging surface 12a changes according to the change in the distance to the object surface (measurement distance). Therefore, the evaluation value reflecting the state of the pattern projected on the imaging surface 12a also changes according to the change in the distance to the object surface (measurement distance). When the current focal distance of the projection lens 34 is FC, if the measurement distance is MC, the pattern is formed on the imaging surface 12a, and the pattern projected on the imaging surface 12a comes into an optimal state. In this case, an optimum evaluation value EV is acquired as the evaluation value.

However, in the example in FIG. 8A, the actual measurement distance is MV, and thus EC is acquired as the evaluation value. In this case, the controller 41 adjusts the focal distance of the projection lens 34 to a focal distance FV such that the difference between the evaluation value EC and the optimum evaluation value EV is eliminated. The focal distance FV is a focal distance at which the optimum evaluation value EV is acquired when the actual measurement distance is MV. By adjusting the focal distance of the projection lens 34 as described above, the pattern of the pattern light is formed on the imaging surfaces 12a and 22a in a proper distribution state.

A correction amount for the focal distance can be obtained by the difference between the evaluation value EC acquired with the current focal distance FC and the optimum evaluation value EV. As shown in FIG. 8B, the correction amount may be obtained from a table in which an evaluation value acquired with the current focal distance and a correction amount for the focal distance are associated with each other. In this case, the controller 41 stores this table in the internal memory thereof in advance, extracts a correction amount associated with the current focal distance and the evaluation value from the table, and performs the adjustment in step S110 in FIG. 7.

When the focal distance of the projection lens 34 is adjusted by the liquid lens as described above, the focal distance and the correction amount specified in the table may be specified by the value of the voltage applied to the liquid lens. In this case, the correction amount does not have to be the difference in voltage value, but may be the value of the voltage applied to the liquid lens itself.

The relationship between the measurement distance and the evaluation value shown in FIG. 8A is merely an example to conceptually illustrate the method for adjusting the focal distance, and the graph showing this relationship may change depending on the content of the evaluation value.

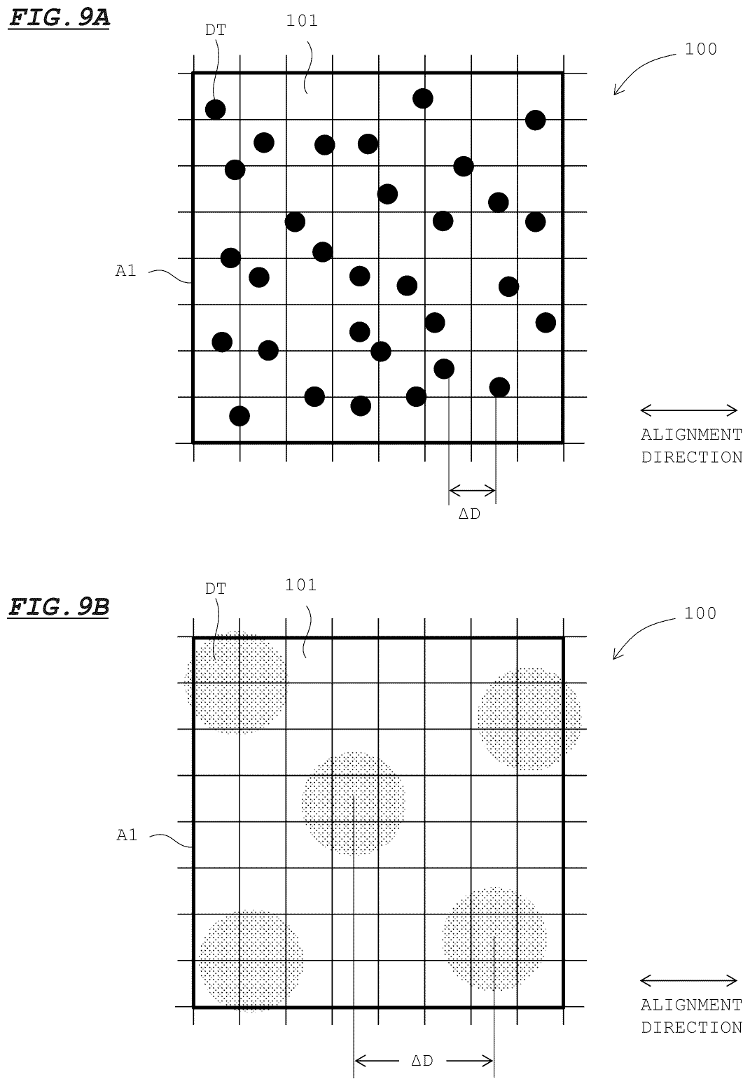

FIG. 9A and FIG. 9B each illustrate a method for acquiring an evaluation value.

FIG. 9A shows the pattern of the pattern light included in the first image 100 when the pattern of the pattern light is properly projected onto the imaging surface 12a, and FIG. 9B shows the pattern of the pattern light included in the first image 100 when the pattern of the pattern light is not properly projected onto the imaging surface 12a.

When FIG. 9A and FIG. 9B are compared, the spatial frequency (density) of the pattern (dots DT) included in the first image 100 is significantly different therebetween. Therefore, the spatial frequency of the pattern (dots DT) included in the first image 100 can be used as one evaluation value.

In this case, as an evaluation value representing the spatial frequency, the average luminance of a plurality of pixel regions 101 included in an evaluation value acquisition target region A1 set in the first image 100 can be acquired. As the average luminance, a value obtained by integrating the luminance values of all the pixel regions 101 included in the evaluation value acquisition target region A1 can be used as it is. Alternatively, as the average luminance, a value obtained by dividing the value obtained by integrating the luminance values of all the pixel regions 101 included in the evaluation value acquisition target region A1, by the number of pixel regions included in the evaluation value acquisition target region A1, may be used.

Considering that the reflectance of the pattern light on the object surface differs for each object, the above luminance values for obtaining the average luminance may be values obtained by normalizing the luminance values respectively acquired at all the pixel regions 101 included in the evaluation value acquisition target region A1, by the maximum luminance value among these luminance values. Alternatively, if the maximum luminance value of the pixel regions 101 acquired when the pattern is formed on the imaging surface 12a is known in advance, values obtained by normalizing the luminance values of all the pixel regions 101 included in the evaluation value acquisition target region A1 by this maximum luminance value may be used. In this case, the controller 41 may store the maximum luminance value in association with each focal distance in FIG. 8B. The maximum luminance value at each focal distance may be acquired by performing actual measurements prior to the execution of the process in FIG. 7.

When FIG. 9A and FIG. 9B are compared, an interval ΔD of the pattern (dots DT) included in the first image 100 is significantly different therebetween. Therefore, the average interval of the pattern (dots DT) included in the first image 100 can be used as one evaluation value.

In this case, as an evaluation value representing the average interval, a value obtained by extracting pixel regions 101 each having a peak luminance value from among all the pixel regions 101 included in the evaluation value acquisition target region A1 and integrating the intervals (numbers of pixels) between the adjacent pixel regions 101 out of the extracted pixel regions 101, can be used. Here, each pixel region 101 having a peak luminance value can be extracted as a pixel region 101 having a higher luminance value than any of the pixel regions 101 surrounding this pixel region 101. The interval (number of pixels) between the pixel regions 101 each having a peak luminance value may be extracted only in the horizontal direction in FIG. 9B (alignment direction of the first imaging part 10 and the second imaging part 20), or may be extracted in both the horizontal direction and the vertical direction in FIG. 9B.

When FIG. 9A and FIG. 9B are compared, the size and the luminance of one pattern element (dot DT) included in the first image 100 is significantly different therebetween. Therefore, as one evaluation value, the average luminance difference between adjacent pixels in the first image 100 can be used.

In this case, as an evaluation value representing the average luminance difference, a value obtained by integrating the differences in luminance values between pixel regions 101 adjacent to each other out of all the pixel regions 101 included in the evaluation value acquisition target region A1, can be used. Alternatively, a number obtained by dividing this integrated value by the total number of pixel regions 101 included in the evaluation value acquisition target region A1, may be used.

In this case as well, the above luminance values for obtaining the differences may be values obtained by normalizing the luminance values respectively acquired at all the pixel regions 101 included in the evaluation value acquisition target region A1, by the maximum luminance value.

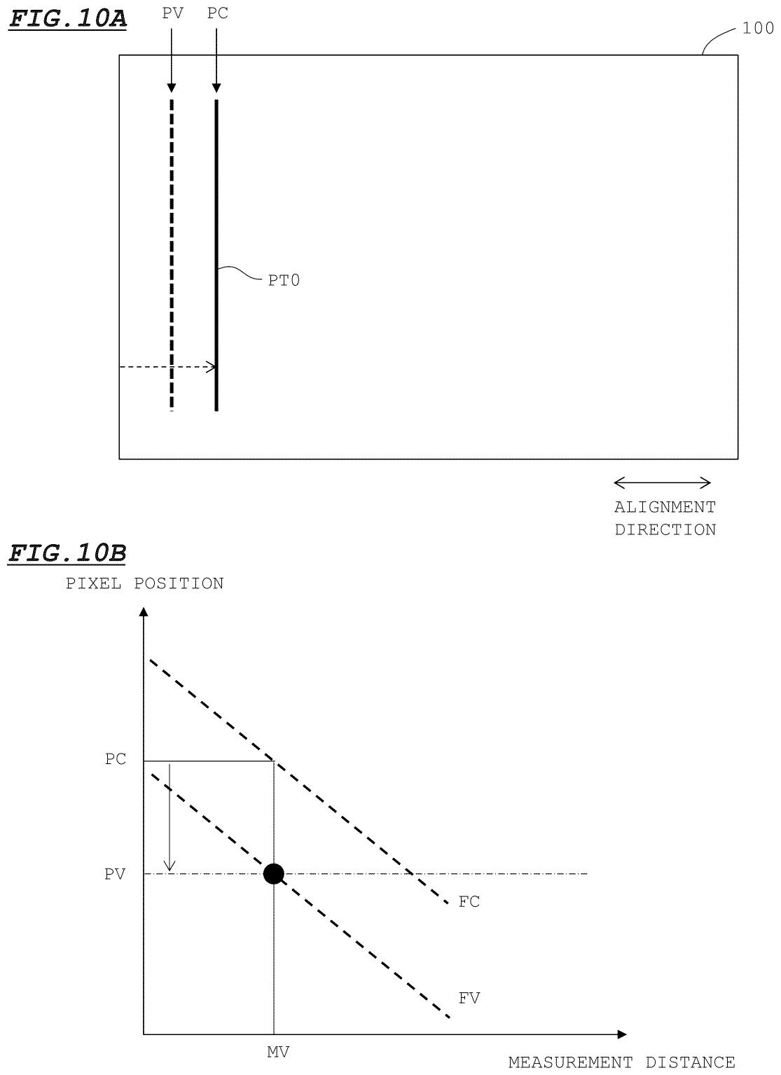

FIG. 10A and FIG. 10B each illustrate another method for acquiring an evaluation value.

In this method, a pattern for evaluation value acquisition is included in the pattern of the pattern light. In the example in FIG. 10A, a pattern PTO for evaluation value acquisition is a linear pattern extending vertically. When the pattern of the pattern light is properly formed on the imaging surface 12a at the current focal distance, the pattern PTO for evaluation value acquisition appears at an optimal pixel position PV on the first image 100.

In FIG. 10A, the pattern of the pattern light is not properly formed on the imaging surface 12a, and thus the pattern PTO for evaluation value acquisition appears at a pixel position PC. In this case, first, the controller 41 extracts the pattern PTO for evaluation value acquisition from the first image 100. Then, the controller 41 acquires the pixel position PC of the pattern PTO for evaluation value acquisition in the alignment direction of the first imaging part 10 and the second imaging part 20, with respect to the left edge of the first image 100, and adjusts the focal distance of the projection lens 34 using the acquired pixel position PC as the evaluation value described above.

That is, as shown in FIG. 10B, at the current focal distance FC, the pixel position PC is the pixel position corresponding to the measurement distance MV. The controller 41 corrects the focal distance of the projection lens 34 to the focal distance FV at which the optimum evaluation value PV is acquired for the measurement distance MV. By adjusting the focal distance of the projection lens 34 as described above, the pattern of the pattern light is formed on the imaging surfaces 12a and 22a at a proper spatial frequency.

In this case as well, the controller 41 may acquire a correction amount for the focal distance of the projection lens 34 using the same table as in FIG. 8B. In this case, the pixel position PC of the pattern PTO for evaluation value acquisition is specified at the evaluation value in FIG. 8B.

The pattern PTO for evaluation value acquisition is not limited to the linear pattern shown in FIG. 10A, and may be any pattern that can be extracted so as to be distinguishable from the pattern for a search process.

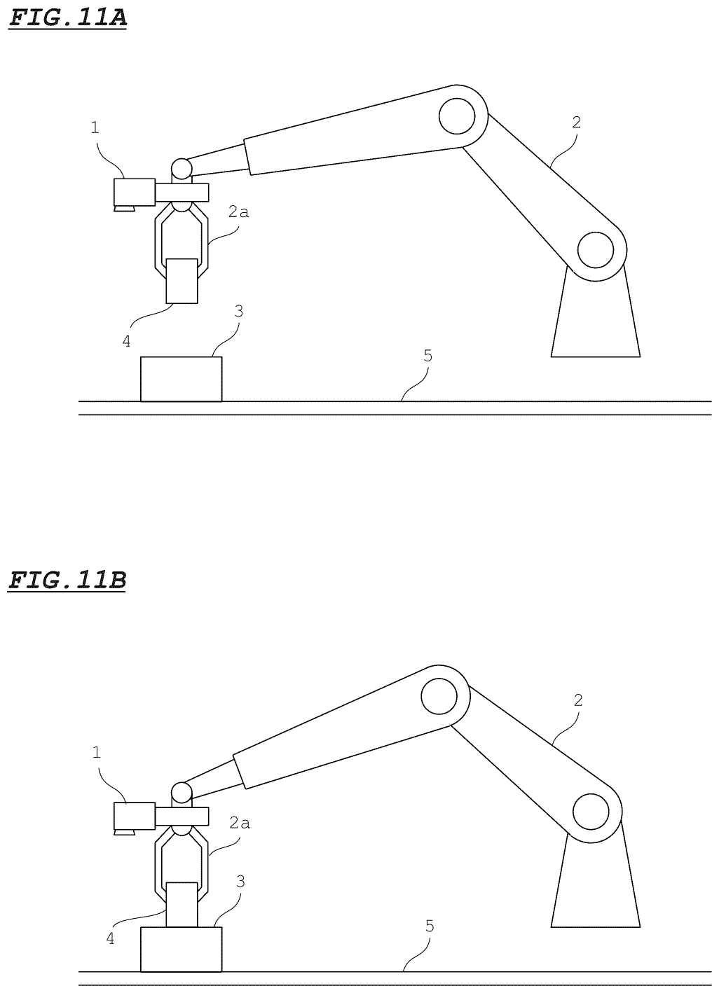

FIG. 11A and FIG. 11B are each a diagram schematically showing an example of the use form of the distance measuring device 1.

In this use form, the distance measuring device 1 is installed near a gripping portion 2a of a robot arm 2. The robot arm 2 places an item 4 onto a container 3 located on a belt conveyor 5. The distance measuring device 1 transmits the distances acquired for all the target pixel blocks TB1 by the above process, to a controller (external device) on the robot arm 2 side in step S109 in FIG. 7. The controller on the robot arm 2 side determines the position of the container 3 and the distance to the container 3, based on the received distance for each target pixel block TB1, and controls the robot arm 2 such that the item 4 is placed on the container 3. Accordingly, the robot arm 2 can smoothly place the item 4 onto the container 3 as shown in FIG. 11B.

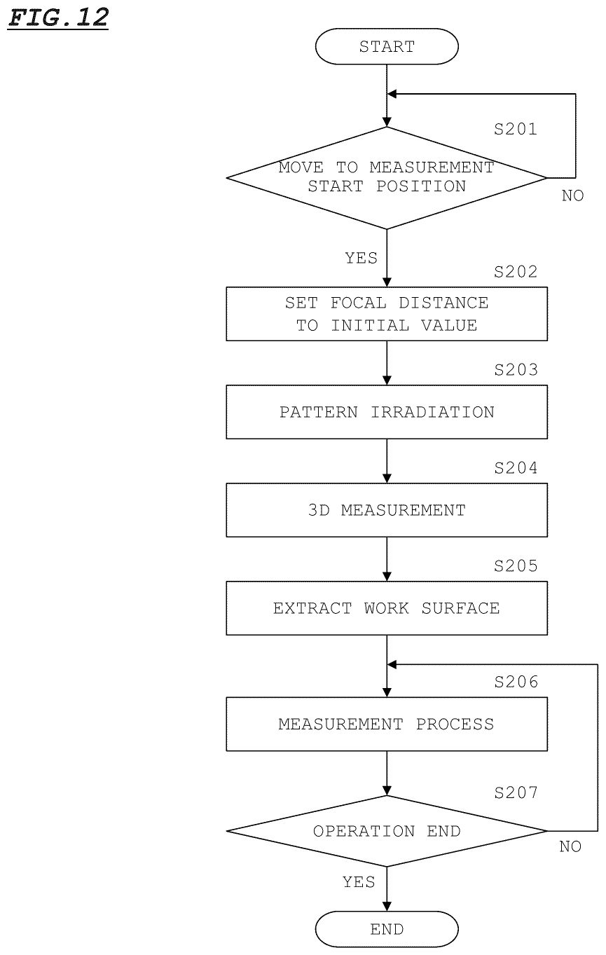

FIG. 12 is a flowchart showing a process executed by the controller 41 during operation of the robot arm 2.

When the gripping portion 2a reaches the start position of distance measurement, a start command is transmitted from the controller on the robot arm 2 side to the controller 41. The controller 41 determines whether or not the gripping portion 2a has reached the start position of distance measurement, based on whether or not this start command has been received (S201).

Then, when the start command is received from the controller on the robot arm 2 side (S201: YES), the controller 41 sets the focal distance of the projection lens 34 to a focal distance that is appropriate when the object surface is at the closest position of the measurement range (S202), and causes the projector 30 to project the pattern light (S203). Then, the controller 41 measures the distance to the surface of the container 3 for each target pixel block TB1, using the first image 100 and the second image 200 acquired during a pattern light irradiation period (S204).

The controller 41 extracts a work surface of the container 3 by the distance thus obtained (S205). In the example in FIG. 11A and FIG. 11B, the work surface is the upper surface of the container 3. The controller 41 executes the measurement process in FIG. 7 for the extracted work surface (S206). Accordingly, a distance for each target pixel block BT1 acquired for the work surface is transmitted to the controller on the robot arm 2 side. Until the operation of placing the item 4 onto the container 3 is completed (S207: NO), the controller 41 repeatedly executes the process in FIG. 7 (S206). Then, when a command indicating the end of the operation is received from the controller on the robot arm 2 side (S207: YES), the controller 41 ends the process in FIG. 12.

### Effects of Embodiment

According to the above embodiment, the following effects are achieved.

As described with reference to FIG. 6A to FIG. 6F, the imaging adjustment part 47 is controlled such that the imaging position of the pattern light is the imaging position corresponding to the distance to the object surface. Therefore, even if the distance to the object surface changes, the pattern (dots DT) can be properly distributed on the imaging surfaces 12a and 22a of the first imaging part 10 and the second imaging part 20. In addition, since the imaging position of the pattern light is adjusted by the imaging adjustment part 47, there is no need to create a plurality of patterns respectively corresponding to a plurality of measurement distances in advance. Therefore, a stereo correspondence point search using the pattern light can be performed properly with a simple configuration.

As described with reference to FIG. 5B and FIG. 6A to FIG. 6F, the controller 41 controls the imaging adjustment part 47 such that the density of the pattern (dots DT) projected on the imaging surfaces 12a and 22a of the first imaging part 10 and the second imaging part 20 is included in the target range Wd. Accordingly, as described with reference to FIG. 5B, the search accuracy of the matching pixel block MB2 which matches the target pixel block TB1 can be increased.

As described with reference to FIG. 8A, the controller 41 controls the imaging adjustment part 47 such that the pattern of the pattern light is formed on the imaging surfaces 12a and 22a of the first imaging part 10 and the second imaging part 20. Accordingly, the luminance and the contrast (difference in shading) of the pattern on the imaging surfaces 12a and 22a can be effectively increased. Thus, the search accuracy of the matching pixel block MB2 which matches the target pixel block TB1 can be increased.

As described with reference to FIG. 8A, the controller 41 acquires an evaluation value allowing evaluation of the projection state of the pattern on the imaging surface 12a, based on the first image 100 acquired by the first imaging part 10, and controls the imaging adjustment part 47 such that the evaluation value approaches the optimum evaluation value acquired when the pattern light is properly formed on the object surface. Accordingly, the pattern can be smoothly and properly distributed in the target state.

As described with reference to FIG. 9A and FIG. 9B, the spatial frequency of the pattern on the first image 100, the average interval of the pattern on the first image 100, or the average luminance difference between the adjacent pixels in the first image 100 can be used as the evaluation value. Accordingly, the state of the pattern can be properly evaluated, and the pattern can be properly distributed in the target state.

As described with reference to FIG. 9A and FIG. 9B, the pattern includes the pattern PTO for evaluation value acquisition, and the position, in the alignment direction of the first imaging part 10 and the second imaging part 20, of the pattern PTO for evaluation value acquisition in the first image 100 can be used as the evaluation value. Accordingly, the state of the pattern can be reliably evaluated, and the pattern can be properly distributed in the target state.

As shown in FIG. 1, the projection lens 34 includes a liquid lens whose focal distance can be changed, and the imaging adjustment part 47 changes the focal distance of the liquid lens to change the imaging position of the pattern light. Accordingly, the imaging position can be changed quickly in accordance with the measurement distance. Thus, a stereo correspondence point search can be performed quickly.

As shown in FIG. 1, the pattern generator 33 is a diffractive optical element. Accordingly, pattern light can be generated with a simple configuration and high light utilization efficiency.

As shown in FIG. 2B, the pattern of the pattern light is a pattern including a random distribution of a plurality of dot regions (dots DT). Accordingly, a pattern specific to each pixel block can be easily distributed.

### Modification 1

In the above embodiment, the imaging position of the pattern light is adjusted based on the evaluation value acquired from the first image 100. In contrast, in Modification 1, the imaging position of the pattern light is adjusted based on information about the distance to the object surface. That is, the controller 41 acquires information about the distance to the object surface to be measured for a distance, from an external device via the communication interface 45, and controls the imaging adjustment part 47 based on the acquired information. Here, the controller for the robot arm 2 shown in FIG. 11A and FIG. 11B is assumed as the external device.

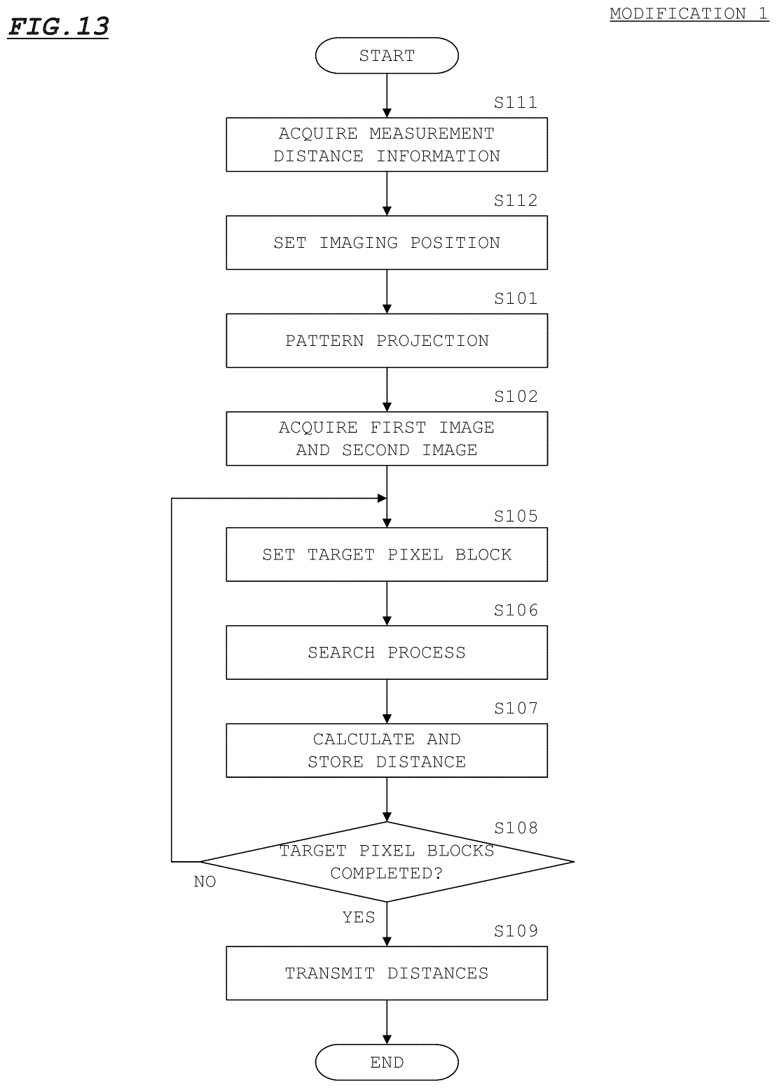

FIG. 13 is a flowchart showing a process for measuring the distance to the object surface according to Modification 1.

In the flowchart in FIG. 13, steps S103, S104, and S110 are omitted from the flowchart in FIG. 7, and steps S111 and S112 are added. The process in steps other than steps S111 and S112 in the flowchart in FIG. 13 is the same as the process in the corresponding steps in FIG. 7.

The controller 41 acquires control position information (3D position, rotation angle, rotation radius, etc.) of the gripping portion 2a of the robot arm 2 from the controller on the robot arm 2 side via the communication interface 45 (S111). The controller 41 calculates an estimated value of the distance to the surface of the container 3 (surface to be measured), based on the acquired control position information, and sets a focal distance (imaging position) corresponding to the calculated estimated value, for the projection lens 34 (S112).

Here, the focal distance (imaging position) set for the projection lens 34 is a focal distance at which the pattern of the pattern light is formed on the imaging surfaces 12a and 22a when the surface to be measured is at the estimated distance. The focal distance (imaging position) may be acquired from a table in which an estimated value of the distance to the surface to be measured and a focal distance (imaging position) are associated with each other. In this case, the controller 41 stores this table in the internal memory thereof in advance. Alternatively, the controller 41 may calculate the focal distance (imaging position) from the estimated value of the distance.

After the focal distance (imaging position) is thus set for the projection lens 34, the controller 41 drives the light source 31 to project the pattern light from the projector 30 (S101). Furthermore, the controller 41 causes the imaging processing part 42 to acquire the first image 100 and the second image 200 (S102). The acquired first image 100 and second image 200 are stored in the storage 43. Then, the controller 41 causes the measurement part 44 to execute a distance calculation process based on a stereo correspondence point search (S105 to S108) and transmit the acquired distance to the controller for the robot arm 2 (S109). The process in steps S105 to S109 is the same as above.

With the configuration of Modification 1, the imaging adjustment part 47 is controlled based on the information about the distance to the object surface such that the pattern of the pattern light is formed on the imaging surfaces 12a and 22a. Therefore, it is possible to easily and quickly shift to the process in step S101 and the subsequent steps in FIG. 13.

### Modification 2

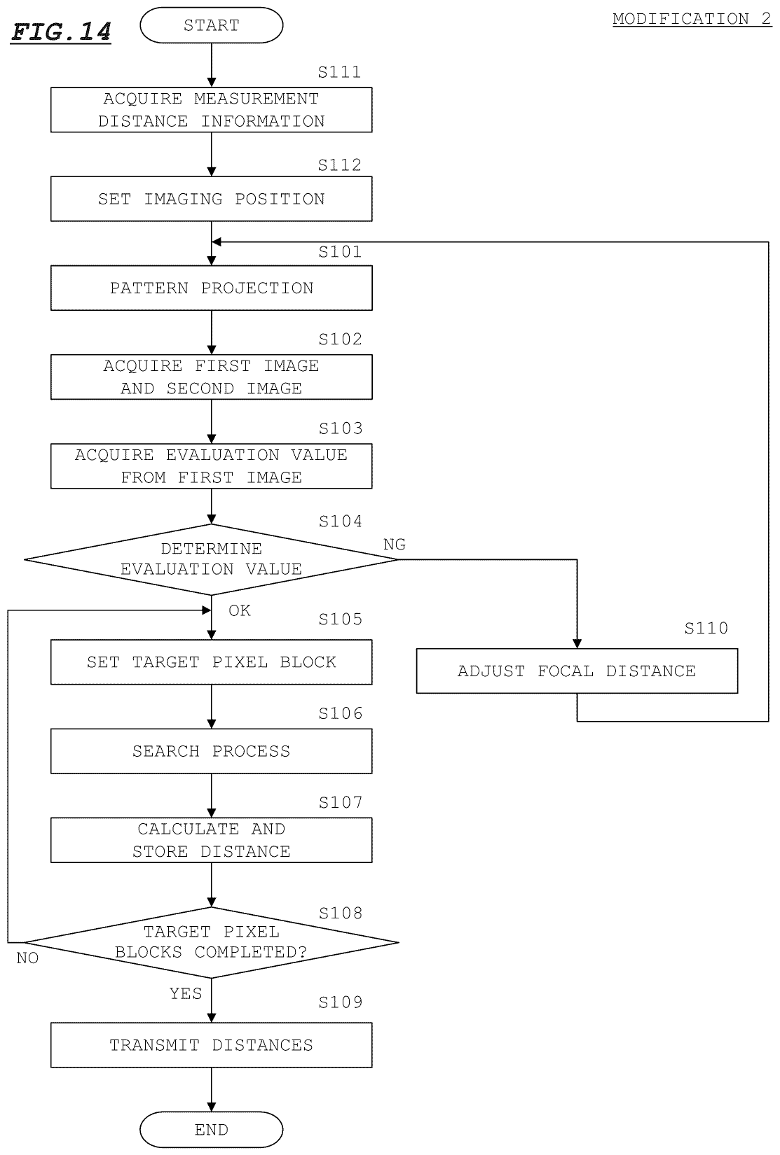

FIG. 14 is a flowchart showing a process for measuring the distance to the object surface according to Modification 2.

In Modification 2, the same process as in the flowchart in FIG. 7 is executed subsequent to steps S111 and S112. The process in each step is the same as the corresponding process in FIG. 7 and FIG. 13. However, in step S101, irradiation with the pattern light is performed at the focal distance set in step S112, not at the initial value of the focal distance.

In the process in FIG. 14, since the focal distance corresponding to the estimated value of the distance to the surface to be measured is set in step S112, the determination in step S104 normally becomes OK. However, for example, if the measurement distance information received from the external device contains a bug or the like, or if there is an unexpected error in the estimation result of the measurement distance, the determination in step S104 becomes NG, and the focal distance corresponding to the distance to the surface to be measured is reset. Therefore, the focal distance corresponding to the distance to the surface to be measured can be reliably set by the projection lens 34. Thus, the stereo correspondence point search can be performed more accurately than in the process in FIG. 13.

### Other Modifications

In the above embodiment and Modifications 1 and 2, the liquid lens is used as the configuration for changing the imaging position of the pattern light, but the configuration for changing the imaging position is not limited thereto. For example, the imaging position of the pattern light may be changed by moving one or more lenses included in the projection lens 34 in the optical axis direction. In this case, an actuator for moving each lens for changing the imaging position, in the optical axis direction, is provided to the projector 30. As this actuator, an electromagnetic actuator using a magnet and a coil or a mechanical actuator using a motor and gears may be used. However, to change the imaging position more quickly, it is preferable to use a liquid lens as described above.

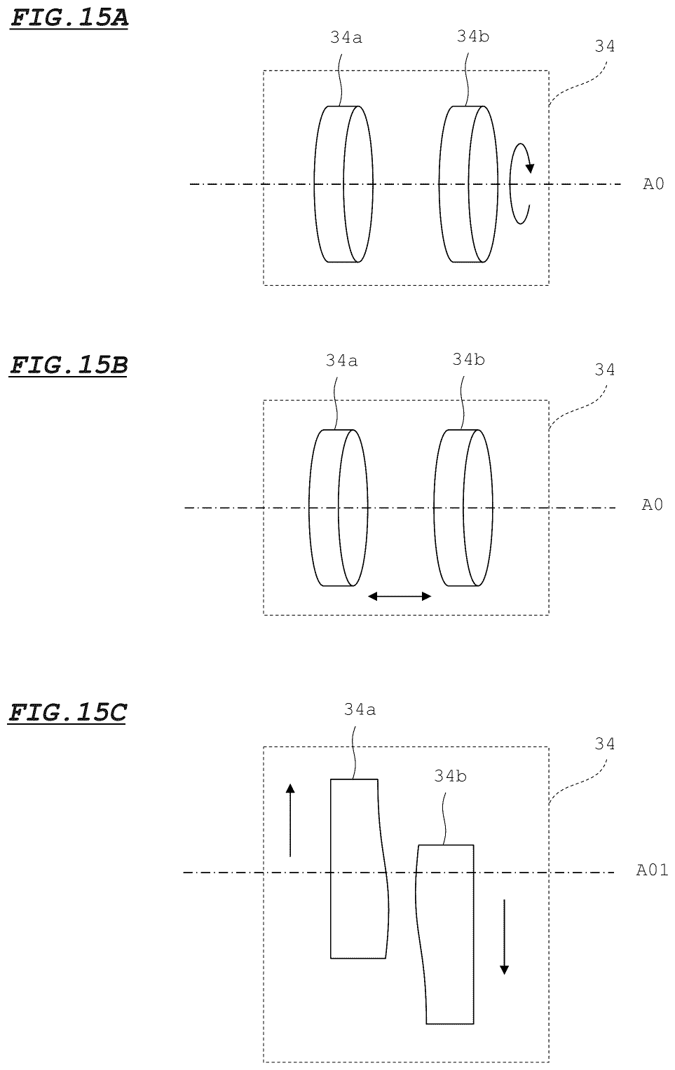

As shown in FIG. 15A to FIG. 15C, the projection lens 34 may include meta-lenses 34a and 34b to change the imaging position of the pattern light.

In the examples in FIG. 15A and FIG. 15B, the two meta-lenses 34a and 34b are placed such that optical axes A0 thereof are aligned with each other. The optical axes A0 constitute the optical axis of the projection lens 34. In the example in FIG. 15A, the focal position of the projection lens 34 is changed by rotating the two meta-lenses 34a and 34b relative to each other around the optical axis A0, and in the example in FIG. 15B, the focal position of the projection lens 34 is changed by changing the interval between the two meta-lenses 34a and 34b in a direction parallel to the optical axis A0. As shown in FIG. 15C, the focal position of the projection lens 34 may be changed by shifting the optical axis of the meta-lens 34b in a direction perpendicular to an optical axis A01 of the meta-lens 34a.

In these configurations as well, actuators for rotating the two meta-lenses 34a and 34b relative to each other, actuators for changing the interval between the two meta-lenses 34a and 34b, or actuators for shifting the two meta-lenses 34a and 34b relative to each other perpendicular to the optical axis are provided. As in the process shown in FIG. 7, these actuators are controlled and the relative rotation angle of the meta-lenses 34a and 34b, the interval in the optical axis direction between the meta-lenses 34a and 34b, and the amount of shift of the meta-lenses 34a and 34b perpendicular to the optical axis are adjusted such that the evaluation value acquired from the first image or the second image is within the proper range.

The above actuators do not necessarily have to be placed for the two meta-lenses 34a and 34b, respectively, and an actuator may be placed for only one of the meta-lenses 34a and 34b and configured to displace the one of the meta-lenses 34a and 34b relative to the other.

By adjusting the focal distance by the meta-lenses 34a and 34b as described above, the number of lenses placed in the projection lens 34 can be reduced, so that the projection lens 34 can be made smaller. In addition, the amount of lens movement when adjusting the focal distance can be reduced, so that the power consumption can be reduced and the adjustment time can be shortened.

In the above embodiment, the imaging position of the pattern light is controlled to the imaging position corresponding to the distance to the object surface, based on the evaluation value acquired from the first image, and in Modification 2, the imaging position of the pattern light is controlled to the imaging position corresponding to the distance to the object surface, based on the measurement distance information. However, the method for controlling the imaging position of the pattern light to the imaging position corresponding to the distance to the object surface is not limited thereto.

For example, the projection lens 34 may be set by AI (artificial intelligence) such that the imaging position of the pattern light is the imaging position corresponding to the distance to the object surface. In this case, for example, the luminance values of all the pixel regions 101 included in the evaluation value acquisition target region A1 shown in FIG. 9A or FIG. 9B are inputted to the AI, and a correction amount for the focal distance or a focal distance to be set is outputted from the AI. In this case, the AI may be trained based on these input and output parameters.

In the above embodiment, the first image 100 is used for acquiring an evaluation value, but the second image 200 may be used for acquiring an evaluation value.

In the above embodiment and Modifications 1 and 2, it is assumed that the imaging position of the projection lens 34 is set such that the pattern of the pattern light is formed on the imaging surfaces 12a and 22a, but the pattern of the pattern light does not necessarily have to be formed exactly on the imaging surfaces 12a and 22a. As long as the search accuracy shown in FIG. 5B is maintained high in the distance range to be measured, the imaging position of the projection lens 34 after control may deviate slightly from the imaging surfaces 12a and 22a.

The pattern of the pattern light does not necessarily have to be a pattern in which dots are randomly distributed, and may be another pattern as long as the pattern has specificity for each pixel block at least in the search range R0.

In the above embodiment and Modifications 1 and 2, two imaging parts, the first imaging part 10 and the second imaging part 20, are used, but three or more imaging parts may be used. In this case, these imaging parts are placed such that fields of view thereof overlap each other, and the pattern light is projected to a range where the fields of view overlap. In addition, the stereo correspondence point search is performed between the paired imaging parts. In this case as well, as in the above, the imaging adjustment part 47 may be controlled such that the imaging position of the pattern light is the imaging position corresponding to the distance to the object surface.

The use form of the distance measuring device 1 is not limited to the use form shown in FIG. 11A and FIG. 11B, and the distance measuring device 1 may be used for another system that performs predetermined control by using the distance to an object surface. In addition, the configuration of the distance measuring device 1 is not limited to the configuration shown in the above embodiment, and, for example, a photosensor array having a plurality of photosensors arranged in a matrix may be used as each of the imaging elements 12 and 22.

In addition to the above, various modifications can be made as appropriate to the embodiment of the present invention, without departing from the scope of the technological idea defined by the claims.

What is claimed is:

1. A distance measuring device comprising:
a first imaging part and a second imaging part placed so as to be aligned such that fields of view thereof overlap each other;
a projector configured to project pattern light distributed in a predetermined pattern, to a range where the fields of view overlap;
a measurement part configured to perform a stereo correspondence point search process for images acquired by the first imaging part and the second imaging part, respectively, to measure a distance to an object surface onto which the pattern light is projected; and
a controller configured to control the projector, wherein
the projector includes
a light source,
a pattern generator configured to generate the pattern light from light emitted from the light source,
at least one projection lens configured to project the pattern light, and
an imaging adjustment part configured to change an imaging position of the pattern light by the projection lens in an optical axis direction of the projection lens, and
the controller controls the imaging adjustment part such that a density of the pattern projected on imaging surfaces of the first imaging part and the second imaging part is included in a target range.

2. The distance measuring device according to claim 1, wherein
the controller
acquires an evaluation value allowing evaluation of a state of the pattern, based on the image acquired by the first imaging part or the second imaging part, and
controls the imaging adjustment part such that the evaluation value approaches an optimum evaluation value acquired when the pattern light is properly formed on the object surface.

3. The distance measuring device according to claim 2, wherein the evaluation value is a spatial frequency of the pattern on the image, an average interval of the pattern on the image, or an average luminance difference between adjacent pixels in the image.

4. The distance measuring device according to claim 2, wherein
the pattern includes a pattern for evaluation value acquisition, and
the evaluation value is a position, in an alignment direction of the first imaging part and the second imaging part, of the pattern for evaluation value acquisition in the image.

5. The distance measuring device according to claim 1, wherein the controller acquires information about the distance to the object surface and controls the imaging adjustment part based on the acquired information.

6. The distance measuring device according to claim 1, wherein
the at least one projection lens includes an optical element whose focal distance can be changed, and
the imaging adjustment part changes the focal distance of the optical element to change the imaging position of the pattern light.

7. The distance measuring device according to claim 6, wherein the optical element is a liquid lens or a meta-lens.

8. The distance measuring device according to claim 1, wherein the pattern generator is a diffractive optical element.

9. The distance measuring device according to claim 1, wherein the pattern of the pattern light is a pattern including a random distribution of a plurality of dot regions.
